(19) United States
(12) Patent Application Publication
(10) Pub. No.: US 2009/0089163 A1
(43) Pub. Date: Apr. 2, 2009

(54) METHOD FOR GENERATING AND DISTRIBUTING COUPONS

(76) Inventor: Peigen Jiang, Sammamish, WA (US)

Correspondence Address: PEIGEN JIANG, 19480 SE 28TH PLACE, SAMMAMISH, WA, 98075, US

(21) Appl. No.: 11/865,055

(22) Filed: Sep. 30, 2007

(51) Int. Cl. G06Q 30/00; G06F 17/00

(52) U.S. Cl. 705/14

(57) ABSTRACT

A method for generating and distributing coupons over the Internet is disclosed, which comprises providing a website, verifying a vender's identity by the website, allowing the verified vender to generate coupons by him or herself within the website, displaying the vender generated coupons over the Internet by the website and allowing a consumer to extract the vender generated coupons from the website for printing.

### BACKGROUND

The present invention relates generally to promoting products, and, more particularly, to coupon generation and distribution.

A method for promoting a product or service is to distribute coupons to large number of potential customers who can redeem the coupon upon purchasing the product or service. The coupons generally offer a discount for the product or service purchased by the customers. Conventionally, the coupons are printed on paper and blindly mailed to a large number of people. Paper coupons are costly to print and distribute. Additionally, many of the paper coupons distributed may never be seen, needed or used by a recipient. With the proliferation of the Internet in recent years, such coupons are proposed to be distributed over the Internet. Then a potential customer can print out a coupon of his or her interest with his or her own printer. However, such coupons distributed over the Internet are still generated by a promoter and then uploaded to a website to be displayed over the Internet. The product or service vendors have to go to the promoter to have their coupon distributed, probably for a price.

As such, what is desired is a system and method to allow a product or service vendor to generate and distribute its own coupon, therefore, more efficiently and cost effectively promote the product or service.

### SUMMARY

The present invention discloses a method for generating and distributing coupons over the Internet. According to one aspect of the present invention, the method comprises providing a website, verifying a vender's identity by the website, allowing the verified vender to generate coupons by him or herself within the website, and displaying the vender generated coupons over the Internet by the website.

According to another aspect of the present invention, the website also allows a consumer to extract the vender generated coupons from the website for printing.

According to yet another aspect of the present invention, the website also allows the verified vender to alter the coupons prior generated by the verified vendor in the website at any time without involving anybody other than the verified vender.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 is a block diagram illustrating a web based coupon generation and distribution system according to one embodiment of the present invention.

FIG. 2 is a flow chart illustrating steps of generating and distributing coupons over the Internet according to the embodiment of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The following will provide a detailed description of a system and method to allow a product or service vendor to generate and distribute its own coupon, therefore, more efficiently and cost effectively promote the product or service.

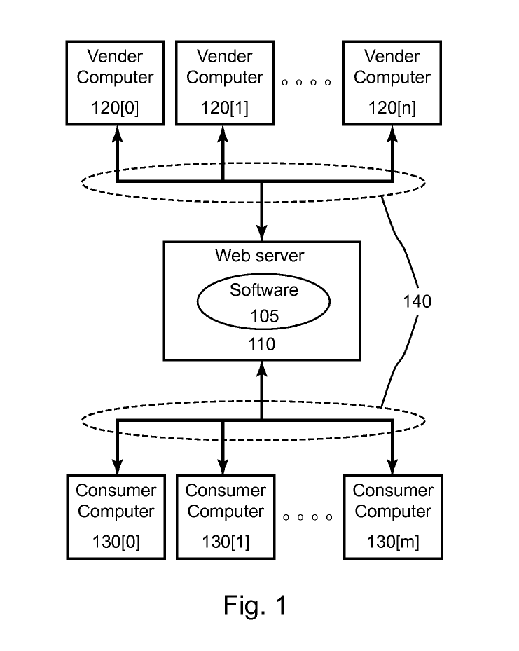

FIG. 1 is a block diagram illustrating a Web based coupon generation and distribution system according to one embodiment of the present invention. The Web, or World Wide Web, is a hypertext system that operates over the Internet, used for serving Web pages and transferring files. The web based coupon generation and distribution system comprises a software system 105 resides in a Web server 110. The software system 105 may generally called “website” that can be simultaneously accessed from a plurality of vender computers 120[0:n], as well as a plurality of consumer computers 130[0:m] through an Internet connection 140, where n and m are integers. The Web server 110 can be implemented by a variety of means including, for example, a Dell PowerEdge server computer running on Microsoft Windows Server operating system. The vender computers 120[0:n] are located at vender locations. The consumer computers 130[0:m] are located at consumer locations. Both the vender computers 120[0:n] and the consumer computers 130[0:m] most often run a Web browser, such as Microsoft Explorer, for communicating with the Web server 110. The computers 120[0:n] and 130[0:m] and the Web server 110 forms a client-server computer architecture.

The software system 105 allows a vender to generate coupons within the software system 105 through a vender computers 120[i], where 0≦i≦n, without human intervention from the Web server 110 side. This may involve the vender's selecting one or more coupon templates provided by the software system 105. The vender can enter coupon texts, such as discount amount and validation period, etc., from the vender computer 120[i]. The vender may also upload images for the coupon from the vender computer 120[i] to the Web server 110. In order to prevent false coupon generation, the software system 105 verifies a vender's identity before allowing the vender to access the coupon generation function thereof. Such verification may involve the vender's pre-registration and a sign-in by the pre-registered vender.

The generated coupons will then be displayed on the software system 105. A consumer may view the coupons at a consumer computer 130[j], where 0≦j≦m, through a Web browser therein. The consumer can download one or more desired coupons to the consumer computer 130[j], and print out the coupons at a local printer coupled to the consumer computer 130[j]. Apparently, the vender can also view the coupons from the vender computer 120[i]. In fact, any Internet connected computer can serve as either the consumer computer 130[i] or the vender computer 120[i]. When accessing coupon viewing and downing functions of the software system 105, the Internet connected computer is a consumer computer. When accessing coupon generating function of the software system 105, the Internet connected computer is a vender computer. A skilled artisan may also realize that the presently disclosed Web based coupon generation and distribution system allows multiple client computers 120 and 130 to access the Web server 110 simultaneously.

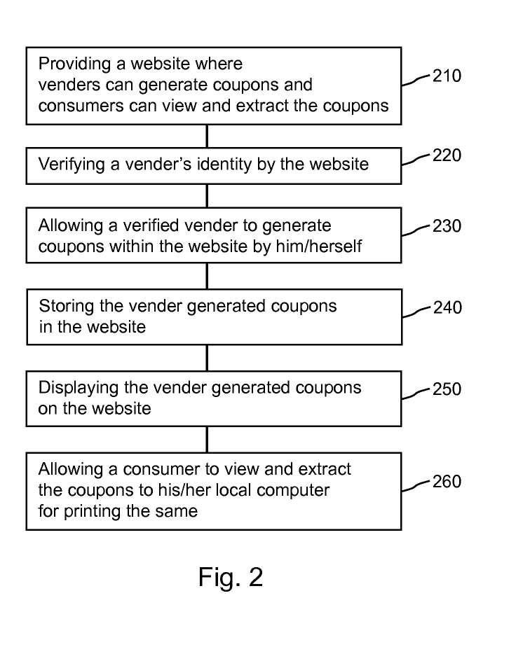

FIG. 2 is a flow chart illustrating steps of generating and distributing coupons over the Internet according to the embodiment of the present invention. In step 210, a coupon service provider provides a website where venders can generate coupons within the website. The generated coupons are then displayed on the website. Consumers can view and extract the coupons by accessing the website. However, before being allowed to generate a coupon, a vender needs to have its identity verified in step 220. Verifying vender's identity is to prevent fraudulent coupon generation. The verifying process may involve a pre-registration, and comparing with the pre-registered information during each access by the vender thereafter. The pre-registration may require the vender who intend to generate and distribute coupons on the website to set up an account by providing proves of ownership of the product or service. The setting up account may include entering an account name and password, which can then be used for verifying purpose during subsequent accessing the website by the vender.

Step 230 shows that the website allows a verified vender to generate coupons within the website by him or herself. The coupon generation process may include template selection, text editing, file uploading and layout editing. A skilled artisan will have no difficulties to write software for the website to perform such functions. Therefore, there will be no need for persons other than the vender's personnel to participate in the coupon generation process.

The website allows the verified vender to store the generated coupons in the website in step 240. The verified vender can also decide when and for how long the generated coupon will be displayed on the website in step 250. In another embodiment of the present invention, the step 250 may also include that the website allows the verified vender to alter or even entirely cancel the displayed coupon.

Step 260 shows that the website allows a consumer to view and select the generated coupons, and also allows the consumer to extract the generated coupons to his or her local computer for being print out. The printed coupons can then be redeemed in designated places when the corresponding products or services are purchased. The coupon information can also be used for redemption in online purchases.

A skilled artisan would also realize that the steps 240, 250 and 260 described above can be executed by the website through software without human participation on the web server side. The verified vender communicates only with the website for executing these steps without involving anybody else.

The coupon generation and distribution system and method of the present invention give venders full control of the coupon generation and distribution process at all time. By leaving at least most of the coupon generation and distribution operations to the website, the coupon service provider can become a leaner and more efficient operator than traditional ones.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for generating and distributing coupons, the method comprising:
providing a website;
verifying a vender's identity by the website;
allowing the verified vender to generate coupons by him or herself within the website; and
displaying the vender generated coupons over the Internet by the website.

2. The method of claim 1, wherein the verifying includes:
pre-registering vender information; and
comparing with the pre-registered information during the vender's later access of the website.

3. The method of claim 1, wherein the allowing the verified vender to generate coupons comprises providing template selection, text editing, file uploading and layout editing.

4. The method of claim 1 further comprising storing the vender generated coupons in the website.

5. The method of claim 1 further comprising:
allowing the verified vender to specify conditions of the coupon displaying on the website; and
executing the coupon displaying by the website according to the specified conditions without human participation.

6. The method of claim 5, wherein the conditions of the coupon displaying include a start time and an end time of the coupon displaying.

7. The method of claim 1 further comprising allowing the verified vender to alter the coupons prior generated by the verified vendor in the website at any time without involving anybody other than the verified vender.

8. The method of claim 1 further comprising allowing a consumer to extract the vender generated coupons from the website for printing.

9. A method for generating and distributing coupons, the method comprising:
providing a website;
verifying a vender's identity by the website;
allowing the verified vender to generate coupons by him or herself within the website;
storing the vender generated coupons in the website;
displaying the vender generated coupons over the Internet by the website; and
allowing a consumer to extract the vender generated coupons from the website for printing.

10. The method of claim 9, wherein the verifying includes:
pre-registering vender information; and
comparing with the pre-registered information during the vender's later access of the website.

11. The method of claim 9, wherein the allowing the verified vender to generate coupons comprises providing template selection, text editing, file uploading and layout editing.

12. The method of claim 9 further comprising:
allowing the verified vender to specify conditions of the coupon displaying on the website; and
executing the coupon displaying by the website according to the specified timings without human participation.

13. The method of claim 12, wherein the conditions of the coupon displaying include a start time and an end time of the coupon displaying.

14. The method of claim 9 further comprising allowing the verified vender to alter the coupons prior generated by the verified vendor in the website at any time without involving anybody other than the verified vender.

15. A method for generating and distributing coupons, the method comprising:
providing a website;
verifying a vender's identity by the website;
allowing the verified vender to generate coupons by him or herself within the website;
displaying the vender generated coupons over the Internet by the website; and
allowing the verified vender to alter the generated coupons in the website at any time without involving anybody other than the verified vender.

16. The method of claim 15, wherein the verifying includes:
pre-registering vender information; and
comparing with the pre-registered information during the vender's later access of the website.

17. The method of claim 15, wherein the allowing the verified vender to generate coupons comprises providing template selection, text editing, file uploading and layout editing.

18. The method of claim 15 further comprising:
allowing the verified vender to specify conditions of the coupon displaying on the website; and
executing the coupon displaying by the website according to the specified conditions without human participation.

19. The method of claim 18, wherein the conditions of the coupon displaying include a start time and an end time of the coupon displaying.

20. The method of claim 15 further comprising allowing a consumer to extract the vender generated coupons from the website for printing.
